(19) United States
(12) Patent Application Publication
(10) Pub. No.: US 2019/0318280 A1
(43) Pub. Date: Oct. 17, 2019

(54) METHOD, SYSTEM, AND DEVICE FOR ONLINE TICKET CHECKING BASED ON A CLIENT INTERFACE

(71) Applicant: BEIJING PONY MEDIA CULTURE DEVELOPMENT CO. LTD., Beijing (CN)

(72) Inventors: Jie CAO, Hangzhou (CN); Yuhui FENG, Hangzhou (CN); Wei MENG, Hangzhou (CN); Xinwei LI, Hangzhou (CN); Shuai HE, Hangzhou (CN); Chongyuan TANG, Hangzhou (CN)

(21) Appl. No.: 16/472,258

(22) PCT Filed: Dec. 14, 2017
(86) PCT No.: PCT/CN2017/116094

§ 371 Date: Jun. 21, 2019

(30) Foreign Application Priority Data
Dec. 21, 2016 (CN) 201611186690.X

(51) Int. Cl. G06Q 10/02; G06F 17/27

(52) U.S. Cl. CPC G06Q 10/02; G06F 17/2725

(57) ABSTRACT

The disclosed embodiments provide a method, system, and device for online ticket checking based on a client interface. The method comprises: receiving a request for an electronic ticket checking interface sent by a client; sending response information to the client after parsing and verifying that identification information of at least one electronic ticket purchased by the client included in the request for an electronic ticket checking interface complies with a ticket checking condition; and receiving password input information acquired by a checking interface sent by the client, comparing whether the password input information is consistent with a password stored in a storage device A of a database, and sending, to the client, ticket checking prompt information based on the result of the comparison. The disclosed embodiments reduce the cost for deployment and networking of ticket checking devices while ensuring ticket checking, and further eliminates admission problems caused by forged (or simulated) passwords.

### CROSS-REFERENCE TO RELATED APPLICATIONS

This application is a national stage entry and claims the benefit of priority of International Application No. PCT/CN2017/116094 filed Dec. 14, 2017 which claims the benefit of priority of Chinese Application No. 201611186690.X filed on Dec. 21, 2016, both of which are hereby incorporated by reference in their entirety.

### BACKGROUND

### Technical Field

The disclosed embodiments relate to the technical field of ticket checking, and particularly, to methods, systems, and devices for online ticket checking via a client interface.

### Description of the Related Art

Currently, there are two main methods for ticket checking. In one method, customers physically present a purchased paper ticket for admission and staff members scan and check the ticket with relevant devices. In a second method, customers physically present an electronic ticket having a dynamic quick response (QR) code of a ticket and staff members scan and check the ticket with relevant devices.

These ticket checking methods have at least the following disadvantages. In the first method, since the object being checked is a paper ticket, duplicate tickets produced by means of photocopying generally cannot be distinguished during checking. Moreover, the authenticity of tickets (when contaminated or damaged) is difficult to verify. In the second method, although the uniqueness of the ticket can be ensured through encryption, dedicated ticket checking devices are required. These devices include, but are not limited to, hand-held PDAs, digital gates, etc. The cost for deploying and networking this equipment deployment is also a significant factor in adoption.

With the current popularity of mobile devices and networks, the mobile office has become an irreversible trend. The same applies now to ticket checking in the ticketing industry.

### SUMMARY

The disclosed embodiments provide methods, systems, and devices for online ticket checking via a client interface. The disclosed embodiments reduce the cost for deployment and networking of ticket checking devices while improving the security of ticket checking.

In one embodiment, a method for online ticket checking based on a client interface is provided. In this embodiment, the method receives a request for an electronic ticket checking interface sent by a client. The method sends response information to the client after parsing and verifying that identification information of at least one electronic ticket purchased by the client included in the request for an electronic ticket checking interface complies with a ticket checking condition. In one embodiment, the response information includes instructions for invoking an electronic ticket checking interface. The method further comprises receiving password input information sent by the client, the password input acquired via a checking interface. The method compares whether the password input information is consistent with a password stored in a storage device A of a database and sends ticket checking prompt information to the client based on the result of the comparison.

In some embodiments, the sending response information further comprises: parsing and verifying whether electronic ticket information included in the request for an electronic ticket checking interface is valid; and sending, to the client, response information including prompt information indicating that the electronic ticket is invalid and ending a ticket checking process if the electronic ticket information included in the request for an electronic ticket checking interface is invalid; determining whether a project session corresponding to the electronic ticket information stored in the storage device A of the database exists in a ticket checking plan if the electronic ticket information included in the request for an electronic ticket checking interface is valid; and sending, to the client, response information including prompt information indicating that the project session corresponding to the electronic ticket does not exist in the ticket checking plan and ending the ticket checking process if the project session corresponding to the electronic ticket information stored in the storage device A of the database does not exist in the ticket checking plan; determining whether the project session corresponding to the electronic ticket information is within ticket checking time if the project session corresponding to the electronic ticket information stored in the storage device A of the database exists in the ticket checking plan; indicating that checking of the electronic ticket has ended, sending, to the client, response information including prompt information indicating that checking of the electronic ticket has ended, and ending the ticket checking process if the project session corresponding to the electronic ticket information is subsequent to the ticket checking time; obtaining a ticket status corresponding to credential information of the electronic ticket if the project session corresponding to the electronic ticket information is within the ticket checking time; sending, to the client, response information including prompt information indicating that the ticket status of the electronic ticket does not comply with the ticket checking condition and ending the ticket checking process if the ticket status does not comply with the ticket checking condition; and sending, to the client, response information including the instructions for invoking an electronic ticket checking interface if the ticket status complies with the ticket checking condition.

In some embodiments, the obtaining a ticket status corresponding to credential information of the electronic ticket if the project session corresponding to the electronic ticket information is within the ticket checking time comprises: sending, to the client, a request for invoking a countdown waiting ticket checking interface of the session corresponding to the electronic ticket if it is determined that the project session corresponding to the electronic ticket information is prior to the ticket checking time and the ticket status corresponding to the credential information of the electronic ticket complies with the ticket checking condition, and displaying a checking interface corresponding to the electronic ticket after a countdown is completed; sending, to the client, the response information including the prompt information indicating that the ticket status of the electronic ticket does not comply with the ticket checking condition and ending the ticket checking process if it is determined that the project session corresponding to the electronic ticket information is prior to the ticket checking time and the ticket status corresponding to the credential information of the electronic ticket does not comply with the ticket checking condition; or obtaining the ticket status corresponding to the credential information of the electronic ticket if it is determined that the project session corresponding to the electronic ticket information is within the ticket checking time.

In some embodiments, the receiving password input information acquired by a checking interface sent by the client comprises: receiving the password input information acquired by the checking interface and sent by the client, and binding and then encrypting the password input information and the identification information of the electronic ticket.

In some embodiments, the comparing whether the password input information is consistent with a password stored in a storage device A of a database, and sending, to the client, prompt information based on the result of the comparison comprise: sending, to the client, prompt information and continuing to receive the password input information if it is determined through comparison that the password input information is inconsistent with the password stored in the storage device A of the database and if it is determined that a current password input attempt number complies with a number for retry attempts; sending, to the client, prompt information and simultaneously locking the checking interface to stop continuing to receive the password input information if it is determined that the number of current password inputs attempt exceeds the number for retry attempts; retrieving a ticket checking status of the electronic ticket in a storage device B of the database if it is determined through comparison that the password input information is consistent with the password stored in the storage device A of the database, and sending, to the client, prompt information of the ticket checking status and ending the ticket checking process if the ticket checking status does not comply with the ticket checking condition; or retrieving a ticket checking status of the electronic ticket in a storage device B of the database if it is determined through comparison that the password input information is consistent with the password stored in the storage device A of the database; and modifying the ticket checking status of the electronic ticket in the storage device B of the database, adding a ticket checking log, and sending, to the client, prompt information indicating a success in ticket checking if the ticket checking status is an unchecked and unchanged ticket.

In some embodiments, a ticket status that does not comply with the ticket checking condition comprises a ticket status selected from the group consisting of a checked ticket, an exchanged ticket, a refunded ticket, and an invalid ticket status. In some embodiments, a ticket status that complies with the ticket checking condition comprises a ticket status selected from the group consisting of an unchecked, unexchanged, and valid ticket status.

In some embodiments, after sending, to the client, prompt information based on the result of the comparison, the method further comprises sending a printing request to a printer to print the electronic ticket information if the prompt information sent to the client is prompt information indicating a success in ticket checking.

In another embodiment, a system for online ticket checking based on a client interface is disclosed. The system comprises: a first receiving module for receiving a request for an electronic ticket checking interface sent by a client; a parsing and verification module for sending response information to the client after parsing and verifying that identification information of at least one electronic ticket purchased by the client included in the request for an electronic ticket checking interface complies with a ticket checking condition, the response information including instructions for invoking an electronic ticket checking interface; and a second receiving module for receiving password input information acquired by a checking interface sent by the client, comparing whether the password input information is consistent with a password stored in a storage device A of a database, and sending, to the client, ticket checking prompt information based on the result of the comparison.

In some embodiments, the parsing and verification module comprises: a first parsing and verification unit for parsing and verifying whether the electronic ticket information included in the request for an electronic ticket checking interface is valid; and sending, to the client, response information including prompt information indicating that the electronic ticket is invalid and ending a ticket checking process if the electronic ticket information included in the request for an electronic ticket checking interface is invalid; a second parsing and verification unit for determining whether a project session corresponding to the electronic ticket information stored in the storage device A of the database exists in a ticket checking plan if the first parsing and verification unit has parsed and verified that the electronic ticket information included in the request for an electronic ticket checking interface is valid; and sending, to the client, response information including prompt information indicating that the project session corresponding to the electronic ticket does not exist in the ticket checking plan and ending the ticket checking process if the project session corresponding to the electronic ticket information stored in the storage device A of the database does not exist in the ticket checking plan; a third parsing and verification unit for determining whether the project session corresponding to the electronic ticket information is within ticket checking time if the second parsing and verification unit has determined that the project session corresponding to the electronic ticket information stored in the storage device A of the database exists in the ticket checking plan; and indicating that checking of the electronic ticket has ended, sending, to the client, response information including prompt information indicating that checking of the electronic ticket has ended, and ending the ticket checking process if the project session corresponding to the electronic ticket information is subsequent to the ticket checking time; a fourth parsing and verification unit for obtaining a ticket status corresponding to credential information of the electronic ticket if the third parsing and verification unit has determined that the project session corresponding to the electronic ticket information is within the ticket checking time; sending, to the client, response information including prompt information indicating that the ticket status of the electronic ticket does not comply with the ticket checking condition and ending the ticket checking process if the ticket status does not comply with the ticket checking condition; and sending, to the client, response information including the instructions for invoking an electronic ticket checking interface if the ticket status complies with the ticket checking condition.

In some embodiments, the fourth parsing and verification unit comprises: a first determination unit for sending, to the client, a request for invoking a countdown waiting ticket checking interface of the session corresponding to the electronic ticket if it is determined that the project session corresponding to the electronic ticket information is prior to the ticket checking time and the ticket status corresponding to the credential information of the electronic ticket complies with the ticket checking condition; and displaying a checking interface corresponding to the electronic ticket after a countdown is completed; or a second determination unit for sending, to the client, the response information including the prompt information indicating that the ticket status of the electronic ticket does not comply with the ticket checking condition and ending the ticket checking process if it is determined that the project session corresponding to the electronic ticket information is prior to the ticket checking time and the ticket status corresponding to the credential information of the electronic ticket does not comply with the ticket checking condition; or a third determination unit for obtaining the ticket status corresponding to the credential information of the electronic ticket if it is determined that the project session corresponding to the electronic ticket information is within the ticket checking time.

In some embodiments, the second receiving module comprises: a second receiving unit for receiving the password input information acquired by the checking interface and sent by the client, and binding and then encrypting the password input information and the identification information of the electronic ticket; a first comparison unit for sending, to the client, prompt information and continuing to receive the password input information if it is determined through comparison that the password input information is inconsistent with the password stored in the storage device A of the database and if it is determined that a current password input attempt number complies with a number for retry attempts; and sending, to the client, prompt information and simultaneously locking the checking interface to stop continuing to receive the password input information if it is determined that the current password input attempt number exceeds the number for retry attempts; a second comparison unit for retrieving a ticket checking status of the electronic ticket in a storage device B of the database if it is determined through comparison that the password input information is consistent with the password stored in the storage device A of the database; and sending, to the client, prompt information of the ticket checking status and ending the ticket checking process if the ticket checking status does not comply with the ticket checking condition; or a third comparison unit for retrieving a ticket checking status of the electronic ticket in a storage device B of the database if it is determined through comparison that the password input information is consistent with the password stored in the storage device A of the database; and modifying the ticket checking status of the electronic ticket in the storage device B of the database, adding a ticket checking log, and sending, to the client, prompt information indicating a success in ticket checking if the ticket checking status is an unchecked and unchanged ticket.

In some embodiments, a ticket status that does not comply with the ticket checking condition comprises a ticket status selected from the group consisting of a checked ticket, an exchanged ticket, a refunded ticket, and an invalid ticket. In some embodiments, a ticket status that complies with the ticket checking condition comprises a ticket status selected from the group consisting of an unchecked, unexchanged, and valid ticket status.

In some embodiments, the system further comprises a printing module for sending a printing request to a printer to print the electronic ticket information if the prompt information sent by the second receiving module to the client is the prompt information indicating a success in ticket checking.

In another aspect, one embodiment further provides an intelligent device comprising the system for online ticket checking based on a client interface based on any of foregoing clauses.

In some embodiments, the intelligent device includes, but is not limited to, intelligent terminals that use H5, Android®, or iOS® interfaces and can connect to the network.

The disclosed embodiments provide the following technical solution: receiving a request for an electronic ticket checking interface sent by a client; sending response information to the client after parsing and verifying that identification information of at least one electronic ticket purchased by the client included in the request for an electronic ticket checking interface complies with a ticket checking condition, the response information including instructions for invoking an electronic ticket checking interface; and receiving password input information acquired by a checking interface sent by the client, comparing whether the password input information is consistent with a password stored in a storage device A of a database, and sending, to the client, ticket checking prompt information based on the result of the comparison. By means of the technical solution above, the disclosed embodiments reduce the costs for deployment and networking of ticket checking devices, meanwhile ensuring ticket checking security. Further, the disclosed embodiments eliminate admission problems caused by forged (or simulated) passwords by adopting the function of online printing receipts (admission certificates or seat certificates) after the ticket is successfully checked.

### BRIEF DESCRIPTION OF THE DRAWINGS

The accompanying drawings that are incorporated in the specification and form part of the specification illustrate embodiments of the disclosure and, together with their description, are used to explain the principles of the disclosed embodiments.

FIG. 1 is a flow diagram illustrating a method for online ticket checking based on a client interface based on some embodiments of the disclosure.

FIG. 2 is a block diagram of a system for online ticket checking based on a client interface based on some embodiments of the disclosure.

FIG. 3 is a block diagram of a parsing and verification module based on some embodiments of the disclosure.

FIG. 4 is a block diagram of a fourth parsing and verification module based on some embodiments of the disclosure.

FIG. 5 is a block diagram of a second receiving module based on some embodiments of the disclosure.

FIG. 6 is a block diagram of an intelligent device based on some embodiments of the disclosure.

### DETAILED DESCRIPTION OF THE EMBODIMENTS

To enable a person skilled in the art to better understand solutions of the disclosure, the technical solutions in the disclosed embodiments will be described clearly and completely below with reference to the drawings. The described embodiments are merely some, rather than all embodiments. Based on the disclosed embodiments, all other embodiments obtained by those of ordinary skill in the art without making creative efforts shall fall within the scope of the disclosure.

It should be noted that the terms “first”, “second”, and the like in the description, drawings, and claims are used to distinguish similar objects and are not necessarily used to describe a specific sequence or order. It should be understood that these numbers may be interchanged where appropriate so that the disclosed embodiments can be implemented in orders other than those illustrated or described herein. In addition, the terms “include” and “have” and any variations thereof are intended to cover non-exclusive inclusions. For example, processes, methods, systems, products, or apparatuses that comprise a series of steps or units are not limited to steps or units that are clearly listed, but may include other steps or units not clearly listed or inherent to these processes, methods, products, or devices.

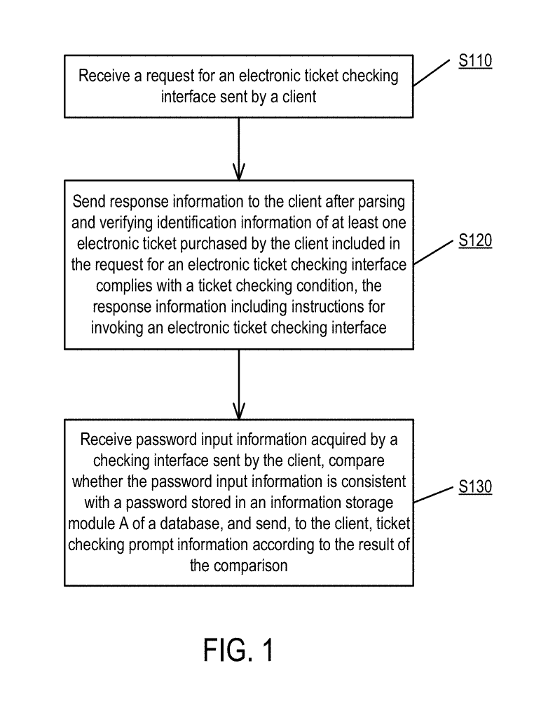

FIG. 1 is a flow diagram illustrating a method for online ticket checking based on a client interface based on some embodiments of the disclosure. The method comprises steps S110, S120, and S130, described in detail herein.

The method illustrated in FIG. 1 can be implemented by a server. A database in the server comprises at least a storage device A, a storage device B, and a storage device C. Different pieces of information are respectively stored in specified modules, which facilitates management and retrieval and relieves the pressure on the server.

In this embodiment, storage device A can be used to store established ticket checking plan information. Storage fields in storage device A include, but are not limited to, ticket checking plan name, project name, project ID, session name, session ID, province, city, performance time, ticket checking starting time, ticket checking ending time, total number of ticket to be checked, venue name, venue map, session type (e.g., real-name session or RFID session), seat type (e.g., numbered seat, unnumbered seat, or no seat), ticket checking method (e.g., admission by an electronic ticket in a ticket folder, admission by an electronic ticket with an ID card, admission by an electronic ticket of an ordinary paper ticket, admission by an RFID paper ticket, and self-defined admission), and MD5 password.

Storage device B can be used to store ticket data information. Storage fields in storage device B include: project name, project ID, session name, session ID, performance time, order number, ticket number, ticket price, venue name, grandstand name, seat number, customer name, customer ID number, phone number, ticket exchange time, ticket exchange status, ticket exchange code, QR code ticket exchange code, RFID electronic label, tax number, ticket checking time, ticket checking status, and order status.

Storage device C is used to record a ticket number for which a wrong password is inputted. Storage fields in storage device C include: ticket number, password error record, and locking record.

In step S110, the method receives a request for an electronic ticket checking interface sent by a client.

For example, a request for an electronic ticket checking interface sent by a client through a mobile web page (such as an H5 web page), Android®, or iOS® interface is received. The client is used to display an electronic ticket checking interface.

In step S120, response information is sent to the client after parsing and verifying identification information of at least one electronic ticket purchased by the client included in the request for an electronic ticket checking interface complies with a ticket checking condition, the response information including instructions for invoking an electronic ticket checking interface.

In one embodiment, step S120 comprises parsing and verifying whether electronic ticket information included in the request for an electronic ticket checking interface is valid; sending, to the client, response information including prompt information indicating that the electronic ticket is invalid (i.e., displaying textual information indicating that the ticket does not exist or the electronic ticket does not exist); and terminating a ticket checking process if the electronic ticket information included in the request for an electronic ticket checking interface is invalid.

Alternatively, or in conjunction with the foregoing, step S120 comprises parsing and verifying whether a unique ticket number identification and a session ID included by the electronic ticket are consistent with a unique ticket number identification and a session ID stored in a server; determining whether a project session corresponding to the electronic ticket information stored in the storage device A of the database exists in a ticket checking plan if the electronic ticket information included in the request for an electronic ticket checking interface is valid (i.e., whether the electronic ticket supports the ticket checking method); sending, to the client, response information including prompt information indicating that the project session corresponding to the electronic ticket does not exist in the ticket checking plan; and terminating the ticket checking process if the project session corresponding to the electronic ticket information stored in the storage device A of the database does not exist in the ticket checking plan.

Alternatively, or in conjunction with the foregoing, step S120 comprises determining whether the project session corresponding to the electronic ticket information is within ticket checking time if the project session corresponding to the electronic ticket information stored in the storage device A of the database exists in the ticket checking plan; indicating that checking of the electronic ticket has ended; sending, to the client, response information including prompt information indicating that checking of the electronic ticket has ended, and terminating the ticket checking process if the project session corresponding to the electronic ticket information is subsequent to the ticket checking time.

Alternatively, or in conjunction with the foregoing, step S120 comprises obtaining a ticket status corresponding to the electronic ticket information stored in a storage device B of a server if the project session corresponding to the electronic ticket information is within the ticket checking time; sending, to the client, response information including prompt information indicating that the ticket status of the electronic ticket does not comply with the ticket checking condition and ending the ticket checking process if the ticket status does not comply with the ticket checking condition; and sending, to the client, response information including the instructions for invoking an electronic ticket checking interface if the ticket status complies with the ticket checking condition.

Herein, a ticket status that does not comply with the ticket checking condition comprises a ticket status selected from the group consisting of a checked ticket, an exchanged ticket, a refunded ticket, and an invalid ticket status. Additionally, a ticket status that complies with the ticket checking condition comprises a ticket status selected from the group consisting of an unchecked, unexchanged, and valid ticket status.

Further, the above-described obtaining a ticket status corresponding to credential information of the electronic ticket if the project session corresponding to the electronic ticket information is within the ticket checking time comprises: if it is determined that the project session corresponding to the electronic ticket information is timestamped prior to is prior to the ticket checking time and the ticket status corresponding to the credential information of the electronic ticket complies with the ticket checking condition (i.e., the ticket status is an unchecked, unexchanged, and valid ticket status), sending, to the client, a request for invoking a countdown waiting ticket checking interface of the session corresponding to the electronic ticket, and displaying a checking interface corresponding to the electronic ticket after a countdown is completed. Alternatively, if it is determined that the project session corresponding to the electronic ticket information is timestamped prior to the ticket checking time and the ticket status corresponding to the credential information of the electronic ticket does not comply with the ticket checking condition (i.e., the ticket status is one of a checked ticket, an exchanged ticket, a refunded ticket, or an invalid ticket status), sending, to the client, the response information including the prompt information indicating that the ticket status of the electronic ticket does not comply with the ticket checking condition, and ending the ticket checking process; or obtaining the ticket status corresponding to the credential information of the electronic ticket if it is determined that the project session corresponding to the electronic ticket information is within the ticket checking time.

In step S130, password input information acquired by a checking interface sent by the client is received; whether the password input information matches a known password stored in a storage device A of a database is compared; and ticket checking prompt information is sent to the client based on the result of the comparison.

Further, in one embodiment of step S130, the receiving password input information acquired by a checking interface sent by the client comprises: receiving the password input information acquired by the checking interface and sent by the client, and binding and then encrypting the password input information and the identification information of the electronic ticket.

The password input information includes, but is not limited to, one or more of graphical password input information, digital password input information, fingerprint password input information, and face recognition password input information.

A scientific research study shows that human has rather limited memory on text, yet human's ability of memory on graphical images is better than that on text. In addition, human memorizes text and images in different ways. At present, many scholars are committed to the study of graphical passwords, which have been applied to personal digital assistants (PDAs), automated teller machines (ATMs), etc. Although many of these models are still in the theoretical and experimental stage and are not commercially applied, they have vast development potential due to their features such as high safety and fun of use. Based on the above-described reasons, the graphical password emerges as the times require. The graphical password is a novel password system in which graphics and the like are used as media and certain operations are required to be performed on the graphics by users upon identity authentication. Because the graphical password has features such as a large password space, flexible application methods, and no use of words, it is immune to brute force attacks and dictionary attacks. Furthermore, some graphical password systems can completely prevent shoulder surfing. In one example, one embodiment uses graphical password input information for checking.

The password of the electronic ticket is stored in the storage device A of the database. When the ticket is checked, a staff member checks the ticket by manually inputting a password in the checking interface of the client. Since the password does not leak, the authenticity of the electronic ticket is ensured.

In one embodiment, step S130 comprises: sending, to the client, prompt information and continuing to receive the password input information if it is determined through comparison that the password input information is inconsistent with the password stored in the storage device A of the database and if it is determined that a current password input attempt number complies with a number for retry attempts. Additionally, step S130 can comprise sending, to the client, prompt information and simultaneously locking the checking interface to stop continuing to receive the password input information if it is determined that the current password input attempt number exceeds the number for retry attempts. The method in step S130 may also retrieve a ticket checking status of the electronic ticket in a storage device B of the database if it is determined through comparison that the password input information is consistent with the password stored in the storage device A of the database. The method may then send, to the client, prompt information of the ticket checking status and end the ticket checking process if the ticket checking status does not comply with the ticket checking condition. Alternatively, or in conjunction with the foregoing, the method may retrieve a ticket checking status of the electronic ticket in a storage device B of the database if it is determined through comparison that the password input information is consistent with the password stored in the storage device A of the database; and modify the ticket checking status of the electronic ticket in the storage device B of the database, add a ticket checking log, and send, to the client, prompt information indicating a success in ticket checking if the ticket checking status is an unchecked and unchanged ticket.

If the server determines that the password input information is inconsistent with the password stored in the storage device A of the database, the server invokes, via a communication interface, a storage device C of the database to add an error record of the electronic ticket (a session for which ticket checking has ended will be automatically cleared of the record), obtain the number of all error records of the electronic ticket, and perform a determination based on a locking record algorithm.

The locking record algorithm described above can be: if the number of times of locking (n_{locked}) (e.g., the total number of errors divided by five,

$$\frac{{n}_{errors}}{5} )$$

is greater than zero (n_{locked}>0) and the remainder of the total number of errors divided by 5 equals zero (nₑᵣᵣₒᵣₛ%5=0), the storage device C is invoked via the communication interface to insert a locking record; and the server invokes, via the communication interface, a mobile phone interface of the client to display a locked page. If the number of times of locking (n_{locked}) (e.g., the total number of errors divided by five,

$$\frac{{n}_{errors}}{5} )$$

is greater than zero (n_{locked}>0), and the remainder of the total number of errors divided by five is greater than zero (nₑᵣᵣₒᵣₛ%5>0), the server invokes, via the communication interface, the mobile phone interface of the client to display “password input error, please retry”. Alternatively, locking can be performed based on freely selected time and number of errors depending on the situation.

A ticket status does not comply with the ticket checking condition comprises a ticket status selected from the group consisting of a checked ticket, an exchanged ticket, a refunded ticket, and an invalid ticket status. Alternatively, or in conjunction with the foregoing, a ticket status that complies with the ticket checking condition comprises a ticket status selected from the group consisting of an unchecked, unexchanged, and valid ticket status.

In the above-described step, the modifying the ticket checking status of the electronic ticket in the storage device B of the database, adding a ticket checking log, and sending, to the client, prompt information indicating a success in ticket checking may comprise: if the ticket status is an unchecked, unexchanged, and valid ticket (e.g., a gifted electronic ticket is valid upon verification), the server modifies a current ticket checking status of the electronic ticket in the storage device B and adds a ticket checking log. If the ticket status is a checked ticket, the server invokes, via the communication interface, a display-interface surface of the client to display the current ticket status as a checked ticket and displays ticket information. If the ticket status is an exchanged ticket, the server invokes, via the communication interface, the display-interface surface of the client to display the current ticket status as an exchanged ticket and displays ticket information. If the ticket status is an invalid ticket (e.g., a gifted ticket wallet is invalid upon verification), the server invokes, via the communication interface, the display-interface surface of the client to display the current ticket status as a gifted ticket and to display ticket information. If the ticket status is a refunded ticket, the server invokes, via the communication interface, the display-interface surface of the client to display that the ticket does not exist.

Further, after sending, to the client, prompt information based on the result of the comparison, the method further comprises sending a printing request to a printer to print the electronic ticket information if the prompt information sent to the client is prompt information indicating a success in ticket checking.

For example, printing can be performed by a page skipping operation. A printing module of the server can invoke a Windows® printer interface to execute a printing instruction and a printer automatically rolls in a piece of ticket paper. Admission problems caused by forged (or simulated) password ticket checking are eliminated by adopting the function of online printing receipts (admission certificates or seat certificates).

With the technical solution of receiving a request for an electronic ticket checking interface sent by a client; sending response information to the client after parsing and verifying that identification information of at least one electronic ticket purchased by the client included in the request for an electronic ticket checking interface complies with a ticket checking condition; and receiving password input information acquired by a checking interface sent by the client, comparing whether the password input information is consistent with a password stored in a storage device A of a database, and sending, to the client, ticket checking prompt information based on the result of the comparison, the method for online ticket checking based on a client interface based on the embodiments described in the description of FIG. 1 reduces the cost for deployment and networking of ticket checking devices while ensuring ticket checking, and further eliminates admission problems caused by forged (or simulated) password ticket checking by adopting the function of online printing receipts (admission certificates or seat certificates) after the ticket is successfully checked.

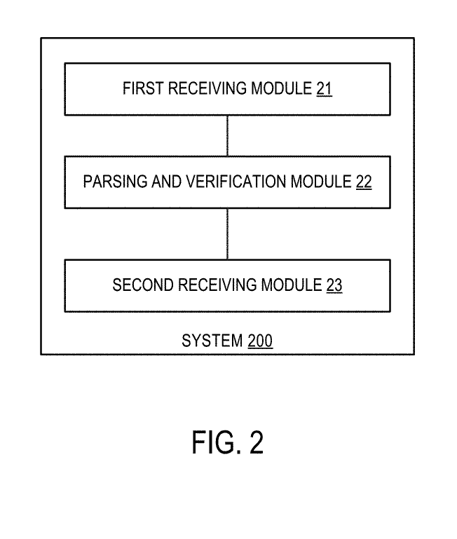

FIG. 2 is a block diagram of a system 200 for online ticket checking based on a client interface based on some embodiments of the disclosure. The system comprises a first receiving module 21, a parsing and verification module 22, and a second receiving module 23.

The first receiving module 21 is used for receiving a request for an electronic ticket checking interface sent by a client.

For example, a request for an electronic ticket checking interface sent by a client through an H5, Android®, or iOS® interface is received. The client is used to display an electronic ticket checking interface.

The parsing and verification module 22 is used for sending response information to the client after parsing and verifying that identification information of at least one electronic ticket purchased by the client included in the request for an electronic ticket checking interface complies with a ticket checking condition, the response information including instructions for invoking an electronic ticket checking interface.

The second receiving module 23 is used for receiving password input information acquired by a checking interface sent by the client, comparing whether the password input information is consistent with a password stored in a storage device A of a database, and sending, to the client, ticket checking prompt information based on the result of the comparison.

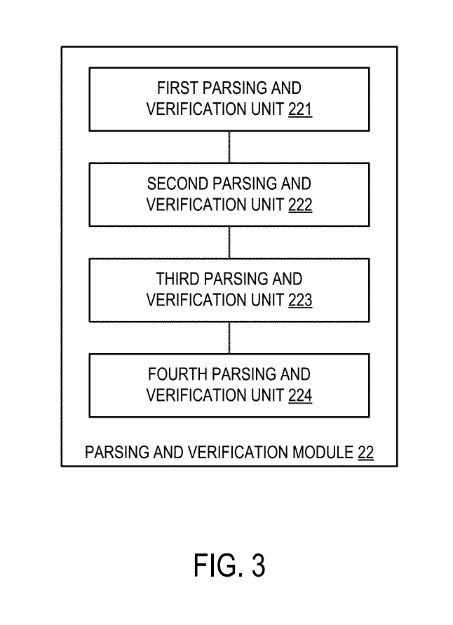

FIG. 3 is a block diagram of a parsing and verification module based on some embodiments of the disclosure. In the illustrated embodiment, the parsing and verification module 22 comprises: a first parsing and verification unit 221, a second parsing and verification unit 222, a third parsing and verification unit 223, and a fourth parsing and verification unit 224.

The first parsing and verification unit 221 is used for parsing and verifying whether the electronic ticket information included in the request for an electronic ticket checking interface is valid; sending, to the client, response information including prompt information indicating that the electronic ticket is invalid and ending a ticket checking process if the electronic ticket information included in the request for an electronic ticket checking interface is invalid.

The second parsing and verification unit 222 is used for determining whether a project session corresponding to the electronic ticket information stored in the storage device A of the database exists in a ticket checking plan if the first parsing and verification unit has parsed and verified that the electronic ticket information included in the request for an electronic ticket checking interface is valid; sending, to the client, response information including prompt information indicating that the project session corresponding to the electronic ticket does not exist in the ticket checking plan; and ending the ticket checking process if the project session corresponding to the electronic ticket information stored in the storage device A of the database does not exist in the ticket checking plan.

The third parsing and verification unit 223 is used for determining whether the project session corresponding to the electronic ticket information is within ticket checking time if the second parsing and verification unit has determined that the project session corresponding to the electronic ticket information stored in the storage device A of the database exists in the ticket checking plan; and indicating that checking of the electronic ticket has ended, sending, to the client, response information including prompt information indicating that checking of the electronic ticket has ended, and ending the ticket checking process if the project session corresponding to the electronic ticket information is subsequent to the ticket checking time.

The fourth parsing and verification unit 224 is used for obtaining a ticket status corresponding to credential information of the electronic ticket if the third parsing and verification unit has determined that the project session corresponding to the electronic ticket information is within the ticket checking time; sending, to the client, response information including prompt information indicating that the ticket status of the electronic ticket does not comply with the ticket checking condition and ending the ticket checking process if the ticket status does not comply with the ticket checking condition; and sending, to the client, response information including the instructions for invoking an electronic ticket checking interface if the ticket status complies with the ticket checking condition.

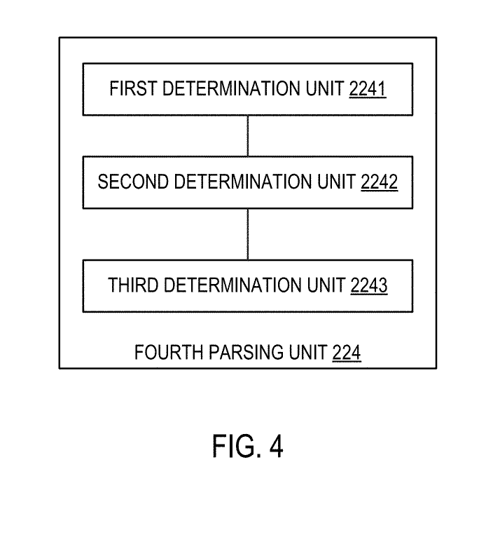

FIG. 4, is a block diagram of a fourth parsing and verification module based on some embodiments of the disclosure. In the illustrated embodiment, the fourth parsing and verification unit 224 comprises a first determination unit 2241, a second determination unit 2242, or a third determination unit 2243.

The first determination unit 2241 is used for sending, to the client, a request for invoking a countdown waiting ticket checking interface of the session corresponding to the electronic ticket if it is determined that the project session corresponding to the electronic ticket information is prior to the ticket checking time and the ticket status corresponding to the credential information of the electronic ticket complies with the ticket checking condition; and displaying a checking interface corresponding to the electronic ticket after a countdown is completed.

The second determination unit 2242 is used for sending, to the client, the response information including the prompt information indicating that the ticket status of the electronic ticket does not comply with the ticket checking condition; and ending the ticket checking process if it is determined that the project session corresponding to the electronic ticket information is prior to the ticket checking time and the ticket status corresponding to the credential information of the electronic ticket does not comply with the ticket checking condition.

The third determination unit 2243 is used for obtaining the ticket status corresponding to the credential information of the electronic ticket if it is determined that the project session corresponding to the electronic ticket information is within the ticket checking time.

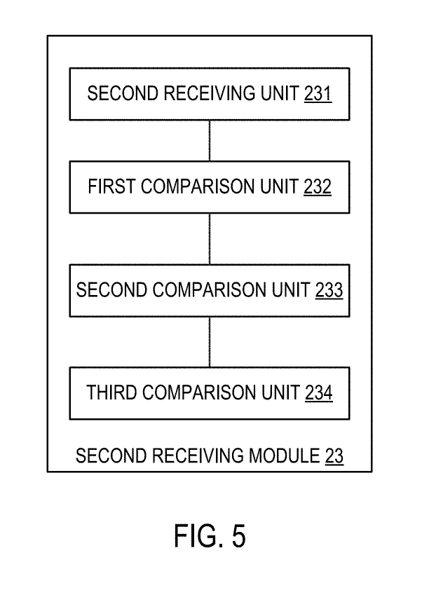

FIG. 5 is a block diagram of a second receiving module based on some embodiments of the disclosure. In the illustrated embodiment, the second receiving module 23 comprises a second receiving unit 231, a first comparison unit 232, a second comparison unit 233, or a third comparison unit 234.

The second receiving unit 231 is used for receiving the password input information acquired by the checking interface and sent by the client, and binding and then encrypting the password input information and the identification information of the electronic ticket.

The first comparison unit 232 is used for sending, to the client, prompt information and continuing to receive the password input information if it is determined through comparison that the password input information is inconsistent with the password stored in the storage device A of the database and if it is determined that a current password input attempt number complies with a number for retry attempts; and sending, to the client, prompt information and simultaneously locking the checking interface to stop continuing to receive the password input information if it is determined that the current password input attempt number exceeds the number for retry attempts.

The second comparison unit 233 is used for retrieving a ticket checking status of the electronic ticket in a storage device B of the database if it is determined through comparison that the password input information is consistent with the password stored in the storage device A of the database; and sending, to the client, prompt information of the ticket checking status and ending the ticket checking process if the ticket checking status does not comply with the ticket checking condition.

The third comparison unit 234 is used for retrieving a ticket checking status of the electronic ticket in a storage device B of the database if it is determined through comparison that the password input information is consistent with the password stored in the storage device A of the database; modifying the ticket checking status of the electronic ticket in the storage device B of the database; adding a ticket checking log; and sending, to the client, prompt information indicating a success in ticket checking if the ticket checking status is an unchecked and unchanged ticket.

Further, a ticket status that does not comply with the ticket checking condition comprises a ticket status selected from the group consisting of a checked ticket, an exchanged ticket, a refunded ticket, and an invalid ticket status. A ticket status that complies with the ticket checking condition comprises a ticket status selected from the group consisting of an unchecked, unexchanged, and valid ticket status.

Further, the system 200 for online ticket checking based on a client interface further comprises a printing module (not shown in the figure) for sending a printing request to a printer to print the electronic ticket information if the prompt information sent by the second receiving module to the client is the prompt information indicating a success in ticket checking. Admission problems caused by forged (or simulated) password ticket checking are eliminated by adopting the function of online printing receipts (admission certificates or seat certificates).

The system 200 for online ticket checking based on a client interface based on one embodiment may comprise a memory and a processor.

The processor can be a Central Processing Unit (CPU), a microprocessor (MCU) etc.

The memory comprises, for example, a ROM (Read Only Memory), a RAM (Random Access Memory), a nonvolatile memory such as a hard disk, and the like.

The memory is used for storing instructions for controlling the processor to operate to perform the method for ticket checking at a client based on one embodiment.

The device 300 (described below) for ticket checking based on a server-recommended ticket checking scheme based on one embodiment may further comprise an interface apparatus, a communication apparatus, an input apparatus, a speaker, a microphone and the like.

The interface apparatus comprises, for example, a USB interface, a headphone interface etc. The communication apparatus is capable of, for example, performing wired or wireless communication, which comprises in particular WiFi communication, Bluetooth communication, 2G/3G/4G/5G communication etc. The input apparatus may comprise, for example, a touch screen, a keyboard, a somatosensory input or the like. A user can input/output speech information through the speaker and microphone.

Since the processing and functions implemented by the system based on the embodiments described in the description of FIGS. 2 through 5 correspond substantially to the embodiments, principles, and examples of the method as previously shown in FIG. 1, non-exhaustive portions in the description of the embodiment can be referred to the related description in the previously described embodiments without repeated description.

With the technical solution in which a first receiving module receives a request for an electronic ticket checking interface sent by a client; a parsing and verification module sends response information to the client after parsing and verifying that identification information of at least one electronic ticket purchased by the client included in the request for an electronic ticket checking interface complies with a ticket checking condition, the response information including instructions for invoking an electronic ticket checking interface; and a second receiving module receives password input information acquired by a checking interface sent by the client, compares whether the password input information is consistent with a password stored in a storage device A of a database, and sends, to the client, ticket checking prompt information based on the result of the comparison, the system 200 for online ticket checking based on a client interface based on the embodiments described in the description of FIGS. 2 through 5 reduces the cost for deployment and networking of ticket checking devices while ensuring ticket checking, and further eliminates admission problems caused by forged (or simulated) password ticket checking by adopting the function of online printing receipts (admission certificates or seat certificates) after the ticket is successfully checked.

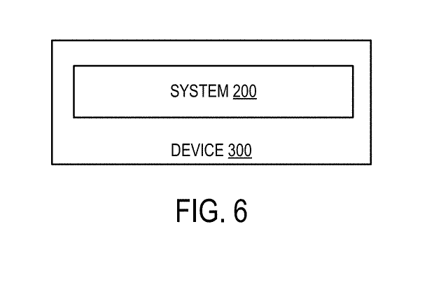

FIG. 6 is a block diagram of an intelligent device based on some embodiments of the disclosure. FIG. 6 illustrates an intelligent device 300 based on some embodiments of the disclosure. The intelligent device 300 comprises the system 200 for online ticket checking based on a client interface based on any of the clauses in the embodiments described in the description of FIGS. 2 through 5.

Further, the intelligent device includes, but is not limited to, intelligent terminals that use H5, Android®, or iOS® interfaces and can connect to the network.

The intelligent device 300 based on one embodiment may comprise a memory and a processor.

The processor can be a Central Processing Unit (CPU), a microprocessor (MCU) etc.

The memory comprises, for example, a ROM (Read Only Memory), a RAM (Random Access Memory), a nonvolatile memory such as a hard disk, and the like.

The memory is used for storing instructions for controlling the processor to operate to perform the method for ticket checking at a client based on one embodiment.

The device 300 for ticket checking based on a server-recommended ticket checking scheme based on one embodiment may further comprise an interface apparatus, a communication apparatus, an input apparatus, a speaker, a microphone and the like.

The interface apparatus comprises, for example, a USB interface, a headphone interface etc. The communication apparatus is capable of, for example, performing wired or wireless communication, which comprises in particular WiFi communication, Bluetooth communication, 2G/3G/4G/5G communication etc. The input apparatus may comprise, for example, a touch screen, a keyboard, a somatosensory input or the like. A user can input/output speech information through the speaker and microphone.

With the technical solution of receiving a request for an electronic ticket checking interface sent by a client; sending response information to the client after parsing and verifying that identification information of at least one electronic ticket purchased by the client included in the request for an electronic ticket checking interface complies with a ticket checking condition, the response information including instructions for invoking an electronic ticket checking interface; and receiving password input information acquired by a checking interface sent by the client, comparing whether the password input information is consistent with a password stored in a storage device A of a database, and sending, to the client, ticket checking prompt information based on the result of the comparison, the intelligent device according the embodiments described in the description of FIG. 6 reduces the cost for deployment and networking of ticket checking devices while ensuring ticket checking, and further eliminates admission problems caused by forged (or simulated) password ticket checking by adopting the function of online printing receipts (admission certificates or seat certificates) after the ticket is successfully checked.

The sequence numbers of the foregoing embodiments are merely for description and do not indicate advantages or disadvantages of the embodiments.

It should be noted that in order to briefly describe each foregoing method embodiment, all the method embodiments are expressed as a combination of a series of actions; but those skilled in the art should know that the disclosed embodiments are not limited by the sequence of the described actions; certain steps can be applied with different sequences or can be included out at the same time based on the disclosed embodiments. Secondly, those skilled in the art should also know that all the embodiments described in the specification belong to exemplary embodiments; the related actions and modules are not necessarily needed for the disclosed embodiments.

In the embodiments, the description of each embodiment has its own focus; and references for those that are not described in detail in a certain embodiment can be made by referring to the related descriptions of other embodiments.

In the disclosed embodiments, the disclosed apparatuses can be implemented in other manners. For example, the apparatus embodiment described above is merely illustrative. For example, the division of the units is merely a logical function division; other division methods in practical implementation may exist, like a plurality of units or components can be combined or can be integrated into another system; or some features can be ignored or are not executed. Additionally, the intercoupling, direct coupling, or communication connection displayed or discussed may be electrical or other forms through some interfaces, indirect coupling or communication connection of the device or the units.

The units described as separate parts may or may not be physically separated; and the parts shown as units may or may not be physical units, which may be located in one place or may be distributed onto a plurality of network units. The objective of the solution of this embodiment may be achieved by selecting part or all of the units based on actual requirements.

In addition, each functional unit in each embodiment may be integrated in one processing unit, or each unit may exist physically independently, or two or more units may be integrated in one unit. The integrated unit may be implemented in the form of hardware, and may also be implemented in the form of a software functional unit.

It is noted that depending on the need for implementation, the various steps/components described in the disclosure can be split into more steps/components, or combine two or more steps/components or part of operations of a step/component into new steps/components to achieve the purpose of the disclosed embodiments.

The disclosed embodiments can be an apparatus, a method and/or a computer program product. The computer program product may comprise a computer-readable storage medium having computer-readable program instructions included thereon for causing a processor to implement various aspects of the disclosed embodiments.

The above-described method based on the disclosed embodiments can be implemented in hardware and firmware, or implemented as software or computer code that can be stored in a recording medium (such as a CDROM, RAM, floppy disk, hard disk, or magneto-optical disk), or implemented as computer code that is downloaded over a network and originally stored in a remote recording medium or a non-transitory machine readable medium and will be stored in a local recording medium, such that the method described herein can be implemented as such software stored in a recording medium by using a general-purpose computer or a dedicated processor, or implemented in programmable or dedicated hardware (such as ASIC or FPGA). It may be appreciated that a computer, a processor, a microprocessor controller, or programmable hardware includes a storage component (e.g., RAM, ROM, Flash, etc.) that can store or receive software or computer code that implements the processing method described herein when accessed and executed by a computer, a processor, or hardware. In addition, when a general-purpose computer accesses code for implementing the processing illustrated herein, the execution of the code converts the general-purpose computer into a dedicated computer for performing the processing illustrated herein.

The computer-readable storage medium can be a tangible device that can hold and store instructions used by instruction execution device. The computer-readable storage medium can be, but is not limited to, for example, an electrical storage device, a magnetic storage device, an optical storage device, an electromagnetic storage device, a semiconductor storage device, or any suitable combination of the above. More specific examples (a non-exhaustive list) of the computer-readable storage medium comprise: portable computer diskettes, hard disks, Random Access Memories (RAMs), Read-Only Memories (ROMs), Erasable Programmable Read-Only Memories (EPROMs or flash memories), Static Random Access Memories (SRAMs), portable Compact Disk Read-Only Memories (CD-ROMs), Digital Versatile Disks (DVDs), memory sticks, floppy disks, mechanical encoding devices (e.g., a punched card or a raised structure in a groove having instructions stored thereon), and any suitable combination of the above. The computer-readable storage medium used herein is not interpreted as transient signals themselves, such as radio waves or other freely propagated electromagnetic waves, electromagnetic waves propagated through a waveguide or other transmission media (e.g., light pulses passing through a fiber optic cable), or electrical signals transmitted through electric wires.

The computer-readable program instructions described herein can be downloaded from a computer-readable storage medium to various computing/processing devices, or downloaded to an external computer or external storage device over a network, for example, the Internet, a local area network, a wide area network, and/or a wireless network. The network may comprise copper transmission cables, fiber optic transmissions, wireless transmissions, routers, firewalls, switches, gateway computers, and/or edge servers. TA network adapter card or network interface in each computing/processing device receives computer-readable program instructions from a network and forwards the computer-readable program instructions for storage in a computer-readable storage medium in each computing/processing device.

Computer program instructions for performing the operations of the disclosed embodiments can be assembly instructions, Instruction Set Architecture (ISA) instructions, machine instructions, machine-related instructions, microcode, firmware instructions, state setting data, or source code or object code written in any combination of one or more programming languages, including object-oriented programming languages such as Smalltalk, C++ or the like, as well as conventional procedural programming languages such as “C” language or similar programming languages. The computer-readable program instructions can be executed entirely or partly on a user computer, executed as a stand-alone software package, executed partly on a user computer and partly on a remote computer, or executed entirely on a remote computer or server. In a case involving a remote computer, the remote computer can connect to a user computer through any type of network, including a Local Area Network (LAN) or Wide Area Network (WAN), or can connect to an external computer (e.g., connect through the Internet by utilizing an Internet service provider). In some embodiments, electronic circuits (e.g., a programmable logic circuit, a field programmable gate array (FPGA), or a programmable logic array (PLA)) are customized by using state information of computer-readable program instructions; the electronic circuits can execute computer-readable program instructions to implement various aspects of the disclosed embodiments.

The various aspects of the disclosed embodiments are described herein with reference to flow charts and/or block diagrams based on the method, apparatus (system) and computer program product based on the embodiments of the disclosure. Each block of the flowcharts and/or block diagrams and combinations of blocks in the flowcharts and/or block diagrams can be implemented by computer-readable program instructions.

The computer-readable program instructions can be provided to a processor of a general-purpose computer, a dedicated computer, or other programmable data processing apparatuses to produce a machine, such that when these instructions are executed by a processor of a computer or other programmable data processing apparatus, means for implementing the functions/acts specified in one or more of the blocks of the flowcharts and/or block diagrams are produced. These computer-readable program instructions can also be stored in a computer-readable storage medium; the instructions cause a computer, a programmable data processing apparatus, and/or other devices to operate in a particular manner, such that the computer-readable medium storing the instructions comprises an article of manufacture that comprises instructions for implementing various aspects of the functions/acts specified in one or more of the blocks of the flowcharts and/or block diagrams.

The computer-readable program instructions can also be loaded onto a computer, other programmable data processing apparatus, or other device, such that a series of operational steps are performed on the computer, other programmable data processing apparatus or other device to generate a computer-implemented process, so that the instructions executed on the computer, other programmable data processing apparatus, or other device implement the functions/acts specified in one or more of the blocks of the flowcharts and/or block diagrams.

The flowcharts and block diagrams in the accompanying drawings illustrate system architectures, functions, and operations of possible implementations of the system, method, and computer program product based on multiple embodiments. In this regard, each block in the flowcharts or block diagrams may represent a portion of a module, program segment, or instruction that contains one or more executable instructions for implementing the specified logical functions. In some alternative implementations, the functions denoted in the blocks can also occur in a different order than that illustrated in the drawings. For example, two consecutive blocks can actually be performed substantially in parallel, sometimes can also be performed in a reverse order, depending upon the functions involved. It is also noted that each block of the block diagrams and/or flowcharts, and combinations of the blocks in the block diagrams and/or flowcharts can be implemented by a dedicated hardware-based system that performs specified functions or actions, or can be implemented by a combination of dedicated hardware and computer instructions. It is well known to those skilled in the art that implementations by hardware, implementations by software, and implementations by a combination of software and hardware are equal.

The above description is only a specific implementation of the disclosed embodiments, and the scope of the disclosed embodiments is not limited thereto. Any person skilled in the art could readily conceive of changes or substitutions within the technical scope disclosed by the disclosed embodiments, which are all intended to be covered by the scope of the disclosure. Thus, the scope of the disclosed embodiments should be based on the scope of the claims.

1-14. (canceled)

15. A method comprising:
receiving, from a client device, a request for an electronic ticket checking interface, the request including identification information of at least one electronic ticket purchased by the client device;
parsing and verifying that the identification information complies with a ticket checking condition;
sending response information to the client device after parsing and verifying the identification information, the response information including instructions for invoking an electronic ticket checking interface;
receiving password input information from the client device, the password input information acquired using the electronic ticket checking interface;
comparing whether the password input information is consistent with a stored password; and
sending, to the client device, ticket checking prompt information based on the result of the comparing.

16. The method of claim 15, the sending response information further comprising sending prompt information indicating that the electronic ticket is invalid and ending a ticket checking process if the electronic ticket information is invalid.

17. The method of claim 15, further comprising:
determining whether a project session corresponding to the electronic ticket information exists in a ticket checking plan if the electronic ticket information is valid;
sending, to the client, prompt information indicating that the project session corresponding to the electronic ticket does not exist in the ticket checking plan; and
ending the ticket checking process if the project session does not exist in the ticket checking plan.

18. The method of claim 17, further comprising:
determining whether the project session corresponding to the electronic ticket information is within a ticket checking time if the project session exists in the ticket checking plan, the ticket checking time indicating that of the electronic ticket has ended;
sending, to the client, response information including prompt information indicating that checking of the electronic ticket has ended, and ending the ticket checking process if the project session is subsequent to the ticket checking time.

19. The method of claim 18, further comprising:
obtaining a ticket status corresponding to credential information of the electronic ticket if the project session is within the ticket checking time;
sending, to the client, prompt information indicating that the ticket status of the electronic ticket does not comply with the ticket checking condition and ending the ticket checking process if the ticket status does not comply with the ticket checking condition; and
sending, to the client, response information including the instructions for invoking an electronic ticket checking interface if the ticket status complies with the ticket checking condition.

20. The method of claim 19, the obtaining a ticket status comprising one or more of:
sending, to the client, a request for invoking a countdown waiting ticket checking interface if it is determined that the project session is prior to the ticket checking time and the ticket status complies with the ticket checking condition, and displaying a checking interface corresponding to the electronic ticket after a countdown is completed;
sending, to the client, prompt information indicating that the ticket status does not comply with the ticket checking condition and ending the ticket checking process if it is determined that the project session is prior to the ticket checking time and the ticket status corresponding to the credential information of the electronic ticket does not comply with the ticket checking condition; or
obtaining the ticket status if it is determined that the project session corresponding to the electronic ticket information is within the ticket checking time.

21. The method of claim 15, the comparing whether the password input information is consistent with a stored password comprising one or more of:
sending, to the client, prompt information and continuing to receive the password input information if it is determined that the password input information is inconsistent with a stored password and if a current password input attempt number complies with a number for retry attempts, and sending, to the client, prompt information and simultaneously locking the checking interface to stop receiving the password input information if the current password input attempt number exceeds the number for retry attempts;
retrieving a ticket checking status of the electronic ticket if the password input information is consistent with the stored password, sending, to the client, prompt information of the ticket checking status and ending the ticket checking process if the ticket checking status does not comply with the ticket checking condition; or
retrieving a ticket checking status of the electronic ticket if the password input information is consistent with the stored password, modifying the ticket checking status of the electronic ticket, adding a ticket checking log, and sending, to the client, prompt information indicating a success in ticket checking if the ticket checking status is an unchecked and unchanged ticket.

22. A non-transitory computer readable storage medium for tangibly storing computer program instructions capable of being executed by a computer processor, the computer program instructions defining the steps of:
receiving, from a client device, a request for an electronic ticket checking interface, the request including identification information of at least one electronic ticket purchased by the client device;
parsing and verifying that the identification information complies with a ticket checking condition;
sending response information to the client device after parsing and verifying the identification information, the response information including instructions for invoking an electronic ticket checking interface;
receiving password input information from the client device, the password input information acquired using the electronic ticket checking interface;
comparing whether the password input information is consistent with a stored password; and
sending, to the client device, ticket checking prompt information based on the result of the comparing.

23. The non-transitory computer readable storage medium of claim 22, the sending response information further comprising sending prompt information indicating that the electronic ticket is invalid and ending a ticket checking process if the electronic ticket information is invalid.

24. The non-transitory computer readable storage medium of claim 22, the instructions further defining the steps of:
determining whether a project session corresponding to the electronic ticket information exists in a ticket checking plan if the electronic ticket information is valid;
sending, to the client, prompt information indicating that the project session corresponding to the electronic ticket does not exist in the ticket checking plan; and
ending the ticket checking process if the project session does not exist in the ticket checking plan.

25. The non-transitory computer readable storage medium of claim 24, the instructions further defining the steps of:
determining whether the project session corresponding to the electronic ticket information is within a ticket checking time if the project session exists in the ticket checking plan, the ticket checking time indicating that of the electronic ticket has ended;
sending, to the client, response information including prompt information indicating that checking of the electronic ticket has ended, and ending the ticket checking process if the project session is subsequent to the ticket checking time.

26. The non-transitory computer readable storage medium of claim 24, the instructions further defining the steps of:
obtaining a ticket status corresponding to credential information of the electronic ticket if the project session is within the ticket checking time;
sending, to the client, prompt information indicating that the ticket status of the electronic ticket does not comply with the ticket checking condition and ending the ticket checking process if the ticket status does not comply with the ticket checking condition; and
sending, to the client, response information including the instructions for invoking an electronic ticket checking interface if the ticket status complies with the ticket checking condition.

27. The non-transitory computer readable storage medium of claim 26, the obtaining a ticket status comprising one or more of:
sending, to the client, a request for invoking a countdown waiting ticket checking interface if it is determined that the project session is prior to the ticket checking time and the ticket status complies with the ticket checking condition, and displaying a checking interface corresponding to the electronic ticket after a countdown is completed;
sending, to the client, prompt information indicating that the ticket status does not comply with the ticket checking condition and ending the ticket checking process if it is determined that the project session is prior to the ticket checking time and the ticket status corresponding to the credential information of the electronic ticket does not comply with the ticket checking condition; and
obtaining the ticket status if it is determined that the project session corresponding to the electronic ticket information is within the ticket checking time.

28. The non-transitory computer readable storage medium of claim 22, the comparing whether the password input information is consistent with a stored password comprising one or more of:
sending, to the client, prompt information and continuing to receive the password input information if it is determined that the password input information is inconsistent with a stored password and if a current password input attempt number complies with a number for retry attempts, and sending, to the client, prompt information and simultaneously locking the checking interface to stop receiving the password input information if the current password input attempt number exceeds the number for retry attempts; or
retrieving a ticket checking status of the electronic ticket if the password input information is consistent with the stored password, sending, to the client, prompt information of the ticket checking status and ending the ticket checking process if the ticket checking status does not comply with the ticket checking condition; or
retrieving a ticket checking status of the electronic ticket if the password input information is consistent with the stored password, modifying the ticket checking status of the electronic ticket, adding a ticket checking log, and sending, to the client, prompt information indicating a success in ticket checking if the ticket checking status is an unchecked and unchanged ticket.

29. A non-transitory computer readable storage medium for tangibly storing computer program instructions capable of being executed by a computer processor, the computer program instructions defining the steps of:
sending, by a client device, a request for an electronic ticket checking interface to a server, the request including identification information of at least one electronic ticket purchased by the client device;
receiving, at the client device, response information from the server after the server parses and verifies the identification information;
invoking, by the client device, an electronic ticket checking interface using instructions included in the response information;
sending, by the client device, password input information to the server, the password input information acquired using the electronic ticket checking interface; and
receiving, at the client device, ticket checking prompt information based on the result of the server comparing whether the password input information is consistent with a stored password.

30. The non-transitory computer readable storage medium of claim 29, the receiving response information comprising receiving information indicating that the electronic ticket is invalid and ending a ticket checking process if the electronic ticket information is invalid.

31. The non-transitory computer readable storage medium of claim 29, the computer program instructions further defining the steps of:
receiving, at the client device, prompt information from the server indicating that a project session corresponding to the electronic ticket does not exist in a ticket checking plan; and
ending, by the client device, the ticket checking process if the project session does not exist in the ticket checking plan.

32. The non-transitory computer readable storage medium of claim 31, the computer program instructions further defining the step of receiving, at the client device, response information from the server including prompt information indicating that checking of the electronic ticket has ended if the project session is subsequent to a ticket checking time, and ending the ticket checking process.

33. The non-transitory computer readable storage medium of claim 32, the computer program instructions further defining the steps of:
receiving, at the client device, prompt information indicating that a ticket status of the electronic ticket does not comply with a ticket checking condition and ending, by the client device, the ticket checking process if the ticket status does not comply with the ticket checking condition; and
receiving, at the client device, response information including the instructions for invoking an electronic ticket checking interface if the ticket status complies with the ticket checking condition.

34. The non-transitory computer readable storage medium of claim 33, the computer program instructions further defining one or more steps of:
receiving, at the client device, a request for invoking a countdown waiting ticket checking interface if it is determined that the project session is prior to the ticket checking time and the ticket status complies with the ticket checking condition, and displaying, by the client device, a checking interface corresponding to the electronic ticket after a countdown is completed;
receiving, at the client device, prompt information indicating that the ticket status does not comply with the ticket checking condition and ending, by the client device, the ticket checking process if it is determined that the project session is prior to the ticket checking time and the ticket status corresponding to credential information of the electronic ticket does not comply with the ticket checking condition; or
obtaining, by the client device, the ticket status if it is determined that the project session corresponding to the electronic ticket information is within the ticket checking time.
The non-transitory computer readable storage medium of claim 29, the password input information acquired using the electronic ticket checking interface comprising password information selected from the group consisting of graphical password input information, digital password input information, fingerprint password input information, and face recognition password input information.
